(19) United States
(12) Patent Application Publication
(10) Pub. No.: US 2021/0104233 A1
(43) Pub. Date: Apr. 8, 2021

(54) INTERACTIVE VOICE FEEDBACK SYSTEM AND METHOD THEREOF

(71) Applicant: EZ-AI CORP., Taipei (TW)

(72) Inventor: YUNG-CHANG HSU, Taipei (TW)

(21) Appl. No.: 17/062,459

(22) Filed: Oct. 2, 2020

(30) Foreign Application Priority Data
Oct. 3, 2019 (TW) 108135903

(51) Int. Cl. G10L 15/18; G10L 15/22; G10L 15/16

(52) U.S. Cl. CPC G10L 15/18; G10L 15/16; G10L 15/22

(57) ABSTRACT

The present invention provides an interactive voice feedback system and method. The interactive voice feedback system includes a feedback server, a smart device, and a learning module. The feedback server is connected to a plurality of natural language processing servers. The feedback server receives the user's voice signal and sends it to a plurality of natural language processing servers. Each natural language processing server generates a corresponding feedback voice signal, and the feedback voice signal includes a weight value. The smart device receives the user's voice message, converts the user's voice message into a user's voice signal, and transmits it. The learning module receives feedback voice signals from each natural language processing server, and the learning module transmits the feedback voice signal having the highest weight value to the smart device.

### CROSS REFERENCE TO RELATED APPLICATION

This application claims the benefit of Taiwan's Patent Application No. 108135903, filed on Oct. 3, 2019, at Taiwan's Intellectual Property Office, the disclosures of which are incorporated herein in their entirety by reference.

### TECHNICAL FIELD

Embodiments of the present disclosure are related to the technical field of interactive voice feedback, and more particularly to an interactive voice feedback system and method for using natural language processing mechanisms with weight conditions to feed messages back to users.

### BACKGROUND

Please refer to FIG. 1, which is a schematic diagram showing a conventional interactive voice feedback system. As shown in FIG. 1, the robot and the cloud natural language processing (NLP) server often communicate with each other in a one-to-one manner. This method can meet most requirements when the early robotic dialogue was mainly imperative. However, with the development of artificial intelligence and the rapid development of hardware functions, the robotic dialogue has become more intelligent and anthropomorphic, and only a single NLP server model used by a robot no longer meets the requirements. In addition, because the communication sentences between the user and the robot are diverse, it is often impossible to accurately respond to the user's questions, and the situation when “answers are not asked” often occurs. Moreover, there is also a situation where a single NLP server cannot interact with the user if the server is disconnected. The above are the shortcomings of conventional robots using a single NLP server in the interactive voice feedback field. In summary, the inventor of the present invention has designed an interactive voice feedback system and method to improve the lack in the prior art, thereby increasing industrial implementation and utilization.

### SUMMARY OF INVENTION

In view of the above-mentioned communication problems, an object of the present invention is to provide an interactive voice feedback system and method for solving the problems or inconveniences encountered in the conventional technology.

Based on the above purpose, the present invention provides an interactive voice feedback system. The interactive voice feedback system includes a feedback server, a smart device, and a learning module. The feedback server is connected to a plurality of natural language processing servers. The feedback server receives the user's voice signal and sends it to a plurality of natural language processing servers. Each natural language processing server generates a corresponding feedback voice signal, and the feedback voice signal includes a weight value. The smart device receives the user's voice message, converts the user's voice message into a user's voice signal, and transmits it. The learning module receives feedback voice signals from each natural language processing server, and the learning module transmits the feedback voice signal having the highest weight value to the smart device.

Preferably, the weight value is set according to a context dialogue type or a general dialogue type to which the natural language processing server belongs.

Preferably, the smart device or the feedback server determines whether the user's voice signal is the context dialogue type, the general dialogue type or a command dialogue type; the smart device directly feedbacks to the user based on the user's voice signal when the user's voice signal is determined to be the command dialogue type; and the feedback server sends the user's voice signal to the respective natural language processing server when the user's voice signal is determined to be the context dialogue type or the general dialogue type.

Preferably, the learning module selects one of a higher weight value from the two feedback voice signals respectively corresponding to the context dialogue type and the general dialogue type.

Preferably, whether the user's voice signal belongs to the command dialogue type is determined according to Word Mover's Distance algorithm; and if not, the user's voice signal is classified into the context dialogue type or the general dialogue type according to a sequence-to-sequence model.

Preferably, the plurality of natural language processing servers include a special natural language processing server; the learning module compares the weight values of the feedback voice signals of the remaining plurality of natural language processing servers; and the smart device feeds back a feedback voice message to the user according to one of a higher weight value between the feedback voice signal of the highest weight value among the remaining plurality of natural language processing servers and the feedback voice signal of the special natural language processing server.

Based on the above purpose, the present invention provides an interactive voice feedback method, which includes the following steps: receiving a user voice message of a user, converting the user voice message into a user voice signal and transmitting it; transmitting the user's voice signal to each of the plurality of natural language processing servers, the plurality of natural language processing servers generate a corresponding feedback voice signal accordingly, and the feedback voice signal includes a weight value; determining the weight value of the plurality of feedback voice signals, and transmitting the feedback voice signals having the highest weight value to the smart device.

Preferably, the method further includes the following step: setting the weight value according to a context dialogue type or a general dialogue type to which the natural language processing server belongs.

Preferably, the method further comprises the following steps: determining whether the user's voice signal is the context dialogue type, the general conversation type, or a command dialogue type; when determining that the user's voice signal is the command dialogue type, the smart device directly makes a feedback to the user based on the user's voice signal; and when determining the user's voice signal is the context dialog type or the general dialog type, the user's voice signal is transmitted to each of the plurality of natural language processing servers.

Preferably, wherein determining the weight value of the plurality of feedback voice signals includes the following steps of: selecting the feedback voice signal, having the highest weight value, corresponding to the context dialogue type or the general dialogue type.

Preferably, further including the following steps of: determining whether the user's voice signal belongs to the command dialogue type according to the Word Mover's Distance algorithm; and if not, then the user's voice signal is classified into the context dialogue type or the general dialogue type according the sequence-to-sequence model.

Preferably, further including the following steps of: setting one of the plurality of natural language processing servers as a special natural language processing server; comparing the weight values of the feedback voice signals of the remaining natural language processing servers to identify the feedback voice signal having the highest weight value; comparing the feedback voice signal having the highest weight value of the remaining natural language processing server with the feedback voice signal of the special natural language processing server; and feeding back a feedback voice message of a higher weight value to the user between the two feedback voice signals in the last comparing step.

The above embodiments and advantages of the present invention will become more readily apparent to those ordinarily skilled in the art after reviewing the following detailed descriptions and accompanying drawings:

### BRIEF DESCRIPTION OF THE DRAWINGS

FIG. 1 is a schematic diagram showing a conventional interactive voice feedback system;

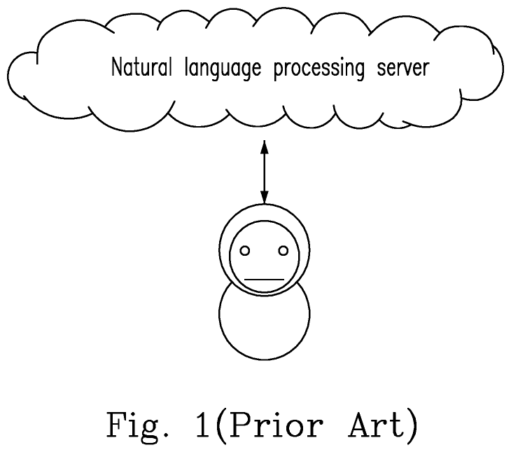

FIG. 2 is a schematic step diagram showing the first embodiment of an interactive voice feedback method;

FIG. 3 is a schematic block diagram showing the first embodiment of an interactive voice feedback system;

FIG. 4 is a schematic step diagram showing the second embodiment of the interactive voice feedback method; and

FIG. 5 is a schematic block diagram showing the second embodiment of the interactive voice feedback system.

### DETAILED DESCRIPTION OF THE PREFERRED EMBODIMENTS

In order to better understand the features, contents and advantages of the present invention and the effects which the present invention can achieve, the present invention is described in detail with the illustrations in the form of examples as follows: The figures and subject used therein are only for the purpose of illustration and auxiliary description for the specification. It may not be the actual proportion and precise configuration after the implementation of the present invention. Therefore, it should not be interpreted and limited to the scope of rights of the present invention in actual implementation according to the actual proportion and precise configuration of the attached drawings.

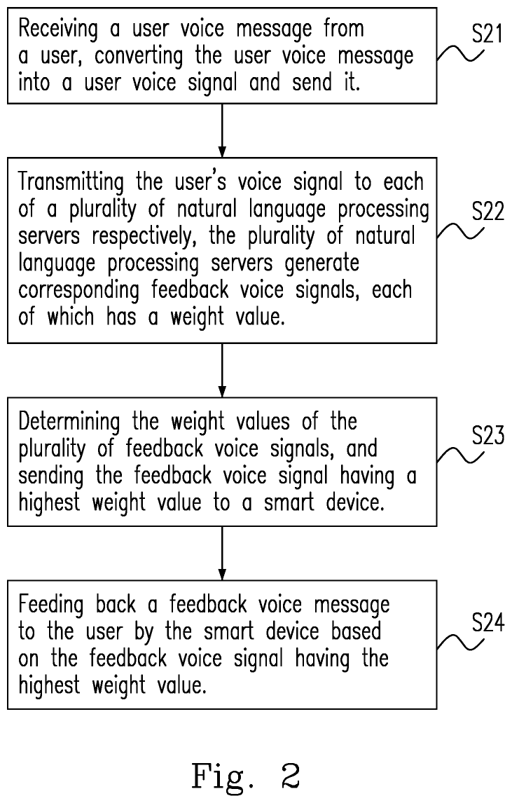

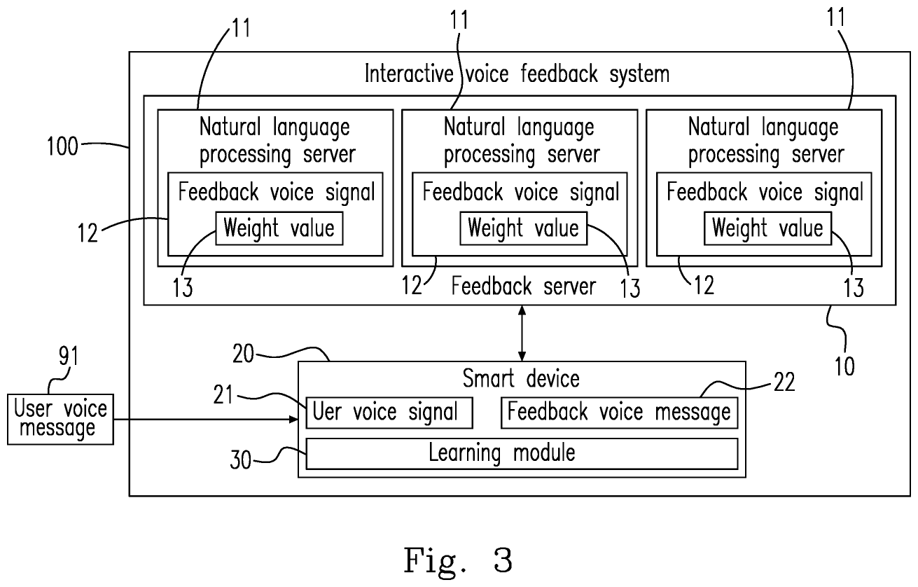

Please refer to FIGS. 2 and 3 together. FIG. 2 is a schematic step diagram showing an interactive voice feedback method according to the first embodiment of the present invention. FIG. 3 is a schematic block diagram showing an interactive voice feedback system 100 according to the first embodiment of the present invention. As shown in FIGS. 2 and 3, the interactive voice feedback method of the present invention is applicable to the interactive voice feedback system 100 of the present invention described below.

The interactive voice feedback system 100 of the present invention includes a feedback server 10, a smart device 20, and a learning module 30. The interactive voice feedback system method of the present invention includes the following steps of:

(S21) receiving a user voice message from a user, converting the user voice message into a user voice signal and sending it.

(S22) transmitting the user's voice signal to each of a plurality of natural language processing servers, wherein the plurality of natural language processing servers generate corresponding feedback voice signals, and each of the corresponding feedback voice signals has a respective weight value.

(S23) determining the weight values of the plurality of feedback voice signals, and sending the feedback voice signal having a highest weight value to a smart device 20.

(S24) feeding back a feedback voice message to the user by the smart device 20 based on the feedback voice signal having the highest weight value.

That is, the user speaks into the smart device 20 in a voice manner; i.e., the smart device 20 receives the user's voice message 91, converts the user's voice message 91 into a corresponding user's voice signal 21, and transmits it to the feedback server 10 under predetermined conditions. The technical means for converting the user voice message 91 into the corresponding user's voice signal 21 is well known to those having ordinary knowledge in the art, and thus it will not be repeatedly described here.

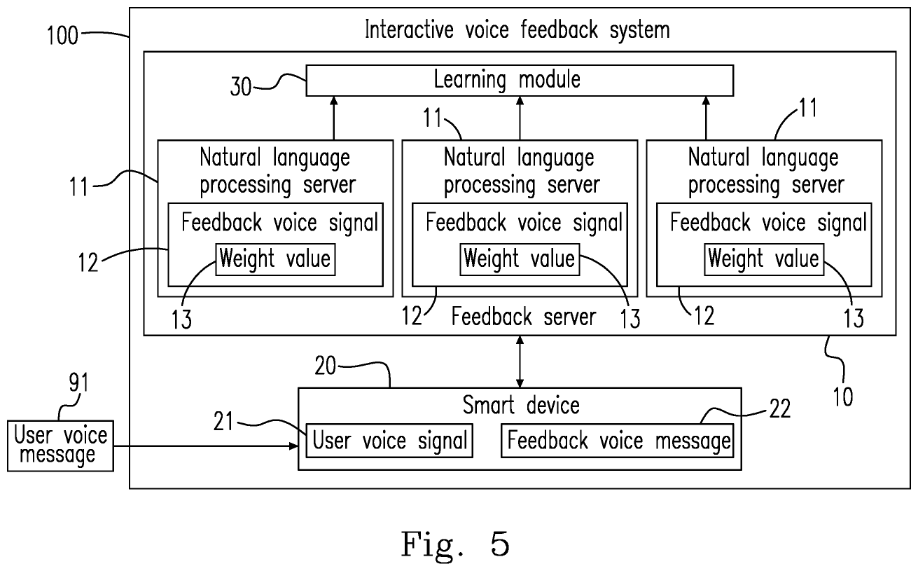

Accordingly, in one embodiment, the user's voice signal 21 can be further transmitted only when it is determined to be a non-command instruction. The feedback server 10 is connected to a plurality of natural language processing servers 11 (FIG. 3 [symbol] FIG. 5 [symbol] ???). After receiving the user's voice signal 21, the feedback server 10 further transmits the user's voice signal 21 to each natural language processing server 11.

Incidentally, a natural language processing is applied to a technology in the fields of artificial intelligence and linguistics. After receiving each user's voice signal 21, each natural language processing server 11 generates a response string according to each semantic model and the corpus engine. The natural language processing server 11 is well known to those having ordinary knowledge in the art, and will not be described again here.

Accordingly, although the communication protocols of each natural language processing server 11 are different, each communication protocol can be unified through the feedback server 10. For example, the feedback server 10 is made with a unified interface used to standardize Http, Https, Restful Web API applied between the communication protocols. Therefore, the present invention can improve the overall dialogue efficiency.

After receiving the user's voice signal 21, the plurality of natural language processing servers 11 can generate a corresponding feedback voice signal 12 accordingly, and each natural language processing server 11 can transmit the feedback voice signal 12 to the feedback server 10.

It is worth noting that the feedback voice signal 12 contains a weight value 13. Then, the learning module 30 judges or analyzes these feedback voice signals 12 to determine which natural language processing server 11 to feed back the feedback voice signal 12 having the highest weight value 13. Then, the learning module 30 transmits the feedback voice signal 12 having the highest weight value 13 to the smart device 20. Finally, the smart device 20 generates a feedback voice message 22 according to the feedback voice signal 12 having the highest weight value 13 and returns the feedback voice message 22 to the user. For example, the smart device 20 has an audio output unit, and may use the audio output unit to output voice for feedback to the user.

It is worth mentioning that the learning module 30 may be disposed in the feedback server 10, the smart device 20, or both. In this preferred embodiment, the learning module 30 is disposed in the smart device 20 as an exemplary aspect, but it should not be used as a limitation. Since the learning module 30 is disposed in the smart device 20, as a whole, the smart device 20 receives the user's voice message 91 from the user. The smart device 20 sends a user voice signal 21 to the feedback server 10. The feedback server 10 transmits a user voice signal 21 to each natural language processing server 11. The feedback server 10 transmits a feedback voice signal 12 of the natural language processing server 11 to the smart device 20. The smart device 20 sends a feedback voice signal 12 to the learning module 30. After the learning module 30 judges, it sends the feedback voice signal 12 having the highest weight value 13 to the smart device 20. The smart device 20 uses components such as an audio output unit to feed back to the user.

In addition, the weight value 13 is set according to a context dialog type or a general dialog type to which the natural language processing server 11 belongs. For example, each natural language processing server 11 has weights respectively set for different context dialogue types or different general dialogue types. Therefore, the feedback voice signal 12 may include a weight value 13 corresponding to the context dialogue type or the general conversation type to which the user voice signal 21 belongs. For example, the first natural language processing server has a weight of 2 for the context dialogue type A1, a weight of 1 for the context dialogue type B1, a weight of 4 for the general dialogue type A2, and a weight of 1 for the general dialogue type B2. The second natural language processing server has a weight of 5 for the context dialogue type A1, a weight of 1 for the context dialogue type B1, a weight of 1 for the general dialogue type A2, and a weight of 2 for the general dialogue type B2. When the user's voice signal 21 belongs to the context dialogue type A1, the feedback voice signal 12 generated by the first natural language processing server includes a weight value 13 of 2, and the feedback voice signal 12 generated by the second natural language processing server includes a weight value 13 of 5.

Incidentally, the above-mentioned weight setting for each natural language processing server 11 can be set according to big data statistics or rule of thumb.

Before transmitting the user's voice signal 21, it can be determined whether the user's voice signal 21 is a context dialogue type, a general dialogue type, or a command dialogue type. When the user's voice signal 21 is determined to be a command dialogue type, the smart device 20 can directly make feedback for the user's corresponding operation according to the user's voice signal 21. When the user's voice signal 21 is determined to be a contextual dialog type or a general dialog type, the user's voice signal 21 is transmitted to each natural language processing server 11. In one embodiment, the context dialogue type may be, for example, a dialogue type for one of finance, physics, otolaryngology, ophthalmology, etc.; and the general dialogue type may be, for example, a dialogue type for general life.

In one embodiment, the user's voice signal 21 is determined to be which one of a context dialogue type, a general dialogue type, or a command dialogue type. Whether the user's voice signal 21 belongs to the command dialogue type is determined according to Word Mover's Distance algorithm, and if not, the user's voice signal is classified into the context dialogue type or the general dialogue type according to a sequence-to-sequence model.

In one embodiment, regarding the selection of the command dialog type, the Word Mover's Distance algorithm is used to calculate the similarity between the input sentence and the command sentence. If the similarity is higher than a threshold (for example, the similarity is higher than 80%), the user's voice signal 21 is determined to be a command dialog type. If the similarity is lower than a threshold (for example, the similarity is less than 80%), the user's voice signal 21 is determined to be a context dialogue type or a general dialogue type.

In one embodiment, the context dialogue type or the general dialogue type is sieved out by using a classifier for sentence types. The classifier is established based on deep learning sequence-to-sequence models and is trained with a corpus of Question-Answer. The main operation is to recognize what kind of context or a general dialog. It is worth mentioning that the context dialogue type belongs to a rule-based natural language processing server, which has the ability to remember context and multi-level dialogue. The general dialog type usually belongs to a natural language processing server, which is established based on a recurrent neural network system and a sequence-to-sequence model, and is mainly used to process situations of the general dialog.

The transmitted user's voice signal 21 can be classified into a context dialog type or a general dialog type. Therefore, the learning module 30 selects the highest weight value 13 as the determined feedback answer for the feedback signal 12, which best corresponds to the context dialogue type or the general dialogue type.

The interactive voice feedback system and method of the present invention utilize the mechanism of a plurality of natural language processing servers and smart devices to solve the problems of the diversity and scalability of traditional single natural language processing servers. In addition, in the interactive voice feedback system and method of the present invention, a feedback sieving server is added between the plurality of natural language processing servers and the smart device to further improve the accuracy of sentence feedback of the smart device by means of weight calculation.

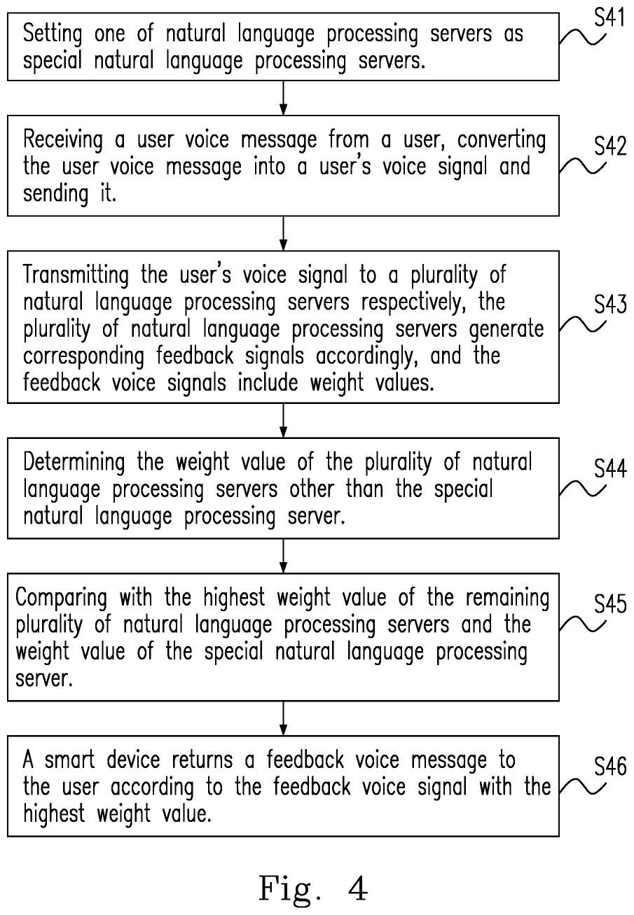

Please refer to FIGS. 4 and 5. FIG. 4 is a schematic step diagram showing an interactive voice feedback method according to the second embodiment of the present invention. FIG. 3 is a schematic block diagram showing an interactive voice feedback system 100 according to the second embodiment of the present invention.

As shown in FIGS. 4 and 5, the interactive voice feedback system 100 of the present invention includes a feedback server 10, a smart device 20, and a learning module 30. The learning module 30 is disposed in the feedback server 10. The interactive voice feedback method of the interactive voice feedback system 100 in the present invention includes the following steps of:

(S41) setting one of a plurality of natural language processing servers as a special natural language processing server.

(S42) receiving a user voice message from a user, converting the user voice message into a user's voice signal and sending it.

(S43) transmitting the user's voice signal to each of the plurality of natural language processing servers, wherein the plurality of natural language processing servers generate corresponding feedback voice signals accordingly, and the feedback voice signals include weight values.

(S44) determining the weight values of the remaining plurality of natural language processing servers other than the special natural language processing server.

(S45) comparing the highest weight value of the remaining plurality of natural language processing servers with the weight value of the special natural language processing server.

(S46) a smart device returns a feedback voice message to the user according to the feedback voice signal with the highest weight value.

Speaking in detail, suppose that the first natural language processing server has a weight of 2 for the context dialogue type A1, a weight of 1 for the context dialogue type B1, a weight of 4 for the general dialogue type A2, and a weight of 1 for the general dialogue type B2. The second natural language processing server has a weight of 5 for the context dialogue type A1, a weight of 1 for the context dialogue type B1, a weight of 1 for the general dialogue type A2, and a weight of 2 for the general dialogue category B2. The third natural language processing server has a weight of 4 for the context dialogue type A1, a weight of 2 for the context dialogue type B1, a weight of 1 for the general dialogue type A2, and a weight of 1 for the general dialogue type B2. In one embodiment, the first natural language processing server is set as a special natural language processing server.

Therefore, the learning module 30 first determines which natural language processing server between the second natural language processing server and the third natural language processing server transmits the feedback voice signal 12 having the highest weight value. In one embodiment, the feedback voice signal 12 generated by the second natural language processing server includes a weight value 13 of 5 when the user's voice signal 21 belongs to the context dialogue type A1, and the third natural language processing server generates a feedback voice signal 12 having a weight value 13 of 4 when the user's voice signal 21 belongs to the context dialogue type A1. Thus, the learning module 30 chooses the feedback voice signal 12 of the second natural language processing server to transmit the feedback voice signal 12 of the second natural language processing server to the smart device 20. On the other hand, the learning module 30 also directly sends the feedback voice signal 12 of the first natural language processing server to the smart device 20.

In one embodiment, the weight value 13 of the feedback voice signal 12 generated by the first natural language processing server is 2, and the feedback voice signal 12 generated by the second natural language processing server includes a weight value 13 of 5. Therefore, the smart device 20 determines to generate a feedback voice message 22 according to the feedback voice signal 12 generated by the second natural language processing server, and return it to the user.

The interactive voice feedback system and method of the present invention utilize multiple mechanisms of a plurality of natural language processing servers and smart devices, such as comparing the feedback of each server one by one or setting the feedback of a special server, etc. It solves the problems of diversity and lack of scalability of traditional single natural language processing servers. In addition, in the interactive voice feedback system and method of the present invention, a feedback sieving server is added between the plurality of natural language processing servers and the smart device to further improve the accuracy of sentence feedback of the smart device by means of weight calculation.

While the invention has been described in terms of what is presently considered to be the most practical and preferred embodiments, it is to be understood that the invention need not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An interactive voice feedback system, including:
a smart device receiving a user voice message from a user, and converting the user voice message into a user's voice signal;
a feedback server connected to the smart device, and receiving the user's voice signal;
a plurality of natural language processing servers connected to the feedback server, and respectively generating a plurality of feedback voice signals according to the user's voice signal, wherein each of the feedback voice signals includes a weight value;
a learning module arranged in the smart device or the feedback server, receiving the plurality of feedback voice signals, and configured to select a feedback voice signal having a highest weight value.

2. The interactive voice feedback system as claimed in claim 1, wherein the weight value is set according to a context dialogue type or a general dialogue type to which each of the natural language processing server belongs.

3. The interactive voice feedback system as claimed in claim 2, wherein the smart device or the feedback server determines whether the user's voice signal is the context dialogue type, the general dialogue type or a command dialogue type, the smart device directly feeds back to the user based on the user's voice signal when the user's voice signal is determined to be the command dialogue type, and the feedback server sends the user's voice signal to the respective natural language processing server when the user's voice signal is determined to be the context dialogue type or the general dialogue type.

4. The interactive voice feedback system as claimed in claim 3, wherein the learning module selects one of a higher weight value from the two feedback voice signals respectively corresponding to the context dialogue type and the general dialogue type.

5. The interactive voice feedback system as claimed in claim 3, wherein: whether the user's voice signal belongs to the command dialogue type is determined according to Word Mover's Distance algorithm, and if not, the user's voice signal is classified into the context dialogue type or the general dialogue type according to a sequence-to-sequence model.

6. The interactive voice feedback system as claimed in claim 1, wherein the plurality of natural language processing servers include a special natural language processing server, the learning module compares the weight values of the feedback voice signals of the remaining plurality of natural language processing servers, the smart device feeds back a feedback voice message to the user according to one of a higher weight value between the feedback voice signal of the highest weight value among the remaining plurality of natural language processing servers and the feedback voice signal of the special natural language processing server.

7. The interactive voice feedback system as claimed in claim 1, wherein the smart device feeds back a feedback voice message to the user according to the feedback voice signal having the highest weight value.

8. An interactive voice feedback method, comprising the following steps:
receiving a user voice message from a user and converting the user voice message into a user's voice signal;
transmitting the user's voice signal to a plurality of natural language processing servers;
through the plurality of natural language processing servers, respectively generating a plurality of feedback voice signals according to the user's voice signal, wherein each of the feedback voice signals includes a weight value; and
selecting a feedback voice signal having a highest weight value.

9. The method as claimed in claim 8, further including the following step of:
setting the weight value according to a context dialogue type or a general dialogue type to which each of the natural language processing server belongs.

10. The method as claimed in claim 9, further including the following steps of:
determining whether the user's voice signal is the context dialogue type, the general dialogue type, or a command dialogue type;
when the user's voice signal is determined to be the command dialogue type, directly feeding back the user based on the user's voice signal to the smart device; and
when the user's voice signal is determined to be the context dialogue type or the general dialogue type, transmitting the user's voice signal to a respective one of the plurality of natural language processing servers.

11. The method as claimed in claim 10, wherein the selecting step includes the following step of:
selecting one of a higher weight value from the feedback voice signals respectively corresponding to the context dialogue type and the general dialogue type.

12. The method as claimed in claim 10, further including the following steps of:
determining whether the user's voice signal belongs to the command dialogue type according to Word Mover's Distance algorithm; and
if not, the user's voice signal is classified into the context dialogue type or the general dialogue type according to a sequence-to-sequence model.

13. The method as claimed in claim 8, further including the following steps of:
setting one of these natural language processing servers as a special natural language processing server;
comparing the weight values of the feedback voice signals of the remaining natural language processing servers to identify the feedback voice signal having the highest weight value;
comparing the feedback voice signal having the highest weight value of the remaining natural language processing server with the feedback voice signal of the special natural language processing server; and
feeding back a feedback voice message of a higher weight value to the user between the two feedback voice signals in the last comparing step.

14. An interactive voice feedback system for a voice interaction between a speaker and an equipment, comprising:
a receiver receiving a voice signal of the speaker;
a plurality of natural language processors connected to the receiver, and simultaneously receiving the voice signal and generating a plurality of feedback voice signals based on the voice signal, wherein each of the natural language processors assigns a weight value to a respective feedback voice signal; and
a selection module receiving the plurality of feedback voice signals, and selecting the feedback voice signal having a highest weight value to provide the equipment therewith, and the equipment feeds back the feedback voice signal having the highest weight value to the speaker.

15. The interactive voice feedback system as claimed in claim 14, wherein:
the receiver is a feedback processor; and
the selection module selects the feedback voice signal having the highest weight value and provides the equipment therewith through the feedback processor.

16. The interactive voice feedback system as claimed in claim 15, wherein the feedback processor is a server or an algorithm engine.

17. The interactive voice feedback system as claimed in claim 14, wherein the speaker is a human or a machine.

18. The interactive voice feedback system as claimed in claim 14, wherein the plurality of natural language processors are respectively installed in a plurality of central processing units.

19. The interactive voice feedback system as claimed in claim 14, wherein each of the natural language processors assigns the weight value according to a field attribute of the feedback voice signal.

20. The interactive voice feedback system as claimed in claim 14, wherein the selection module is a learning module.

21. An interactive voice feedback method for a voice interaction between a speaker and an equipment, comprising the following steps of:
transmitting a voice signal of the speaker to a plurality of natural language processors;
the plurality of natural language processors simultaneously receiving the voice signal and generating a plurality of feedback voice signals based on the voice signal, wherein each of the natural language processors assigns a weight value to a respective feedback voice signal; and
selecting the feedback voice signal having a highest weight value to provide the equipment therewith, and the equipment feeds back the feedback voice signal having the highest weight value to the speaker.

22. The method as claimed in claim 21, wherein the speaker is a human or a machine.

23. The method as claimed in claim 21, wherein the plurality of natural language processors are respectively installed in a plurality of central processing units.

24. The method as claimed in claim 21, wherein each of the natural language processors assigns the weight value according to a field attribute of the feedback voice signal.
